(19) United States
(12) Patent Application Publication
(10) Pub. No.: US 2019/0115012 A1
(43) Pub. Date: Apr. 18, 2019

(54) Robot training method under virtual environment and robot training apparatus under same

(71) Applicant: SHENZHEN GOWILD ROBOTICS CO., LTD, Shenzhen, Guangdong (CN)

(72) Inventors: Haofen Wang, Shenzhen, Guangdong (CN); Nan Qiu, Shenzhen, Guangdong (CN); Xinyu Yang, Shenzhen, Guangdong (CN)

(21) Appl. No.: 15/743,683

(22) PCT Filed: Jul. 7, 2016
(86) PCT No.: PCT/CN2016/089206

§ 371 Date: Jan. 11, 2018

(51) Int. Cl. G10L 15/06; G10L 15/22; G06N 20/00; G05B 19/4155

(52) U.S. Cl. CPC G10L 15/063; G10L 15/22; G05B 2219/40408; G05B 19/4155; G06N 20/00

(57) ABSTRACT

A robot training method under a virtual environment includes receiving voice signals; and controlling a robot in the virtual environment in response to the received voice signals. The voice signals include a training time signal and a training program signal. Prior to training a user may select training time of a desired training program by pronouncing a voice. The user may change the training time of the desired training program. The user may select an optimum training time based on schedule. A robot training method under the virtual environment is also provided.

### BACKGROUND OF THE INVENTION

### 1. Field of the Invention

The invention relates to robot training, and more particularly to a robot training method under a virtual environment and training apparatus under same.

### 2. Description of Related Art

With the development of science and technology, robot training under a virtual environment becomes more advanced, especially in the fields of health and entertainment. In a medical treatment, a patient, going through robot training under a virtual environment, can increase his or her training initiative and interest. Further, the patient may no longer feel boring in the whole training process. Furthermore, the physician can clearly observe a training apparatus being used by the patient. In entertainment, a user may enjoy games being played in a virtual environment.

However, in the conventional technologies, robot training program, training time, etc. of robot training under a virtual environment are preset. When a patient or user wants to change the training program and/or the training time, the patient or user is required to reset same. This means that not only the patient or user has to do the reset by disrupting the training but also it brings inconvenience to the patient or user in training. In addition, it is very inconvenient for injured patients to set a training program and training time many times. Thus, the need for improvement still exists.

### SUMMARY OF THE INVENTION

The technical problem of the invention is to provide a virtual environment based robot training method and robot training apparatus for user training.

The purpose of the invention is achieved through the following technical solutions:

In one aspect of the invention, there is provided a robot training method under a virtual environment comprising the steps of receiving voice signals; and controlling a robot in the virtual environment in response to the received voice signals.

Preferably, the voice signals include a training time signal.

Preferably, the voice signals further comprise a training program signal.

In another aspect of the invention, there is provided a robot training apparatus under a virtual environment, comprising a receiving device for receiving voice signals; and a control device for controlling a robot under the virtual environment based on the received voice signals.

Preferably, the voice signals include a training time signal.

Preferably, the voice signals further comprise a training program signal.

In the conventional technologies, robot training program, training time, etc. of robot training under a virtual environment are preset by a user including a patient. When the user wants to change the training program and/or the training time, the user is required to reset same. This means that not only the user has to do the reset by disrupting the training but also it brings inconvenience to the user in training. In addition, it is very inconvenient for injured users to set a training program and training time many times.

In comparison with the conventional technologies, the robot training method under virtual environment of the invention comprises the steps of receiving voice signals and controlling a robot in the virtual environment in response to the voice signals. Thus, the invention implements a robot training method by voice control. The user can select a desired training program and training time by means of voice signals. And in turn, the user can select a desired training program. Further, the user can shift the training time as desired. In an exemplary example of training time change: in a training program a user selects a 20-minute training time through a voice signal. But approaching the end of the 20 minutes, the user wants to continue the training. Then the user can input a voice signal to the training apparatus to extend the training time to another 10 minutes, 20 minutes, etc. When the user feels tired during the extended period of time and wants to rest, the user can input the voice signal to the training apparatus to terminate the training.

The above and other objects, features and advantages of the invention will become apparent from the following detailed description taken with the accompanying drawings.

### BRIEF DESCRIPTION OF THE DRAWINGS

FIG. 1 is a flow chart illustrating a robot training method under a virtual environment according to the invention; and

FIG. 2 is a block diagram of a robot training apparatus under the virtual environment according to the invention.

### DETAILED DESCRIPTION OF THE INVENTION

The specific structure and functional details discussed herein are only representative and are intended to describe the exemplary example of the invention. But the invention can be implemented in many forms of substitution, and should not be interpreted as merely limited to the embodiments described herein.

In the description of the invention, it is understood that terms “center”, “horizontal”, “up”, “down”, “left”, “right”, “vertical”, “level”, “top”, “bottom”, “inside” and “outside” each indicate a location or position relative to the location or position shown in the accompanying drawings. It intends to the better understanding of description of the invention rather than specify that the invention is limited to such components, devices, method, locations, orientations, and operations either referred to or implied. Therefore it cannot be interpreted as limiting the invention. In addition, the terms “first” and “second” are only used to describe their purposes rather than indicate or suggest the relative importance or implied number of technical characteristics. Thus, the characteristics of “first” and “second” can be defined or implied by one or more of these characteristics. In the description of the invention, unless otherwise specified, “multiple” means two or more. In addition, the term “include” and any similar terms are intended to mean inclusion of non exclusive.

In the description of the invention, unless expressly described rules and limitations, terms “installation”, “interconnected” and “connected” should be interpreted in a general understanding. For example, they can be a fixed connection, a detachable connection, or an integral connection. They could be a mechanical connection or an electrical connection. They can be connected directly or indirectly through intermediaries. They can be connected within two components. An ordinary skilled in the art can understand the specific meaning of these terms in the invention.

The terms used herein are simply to describe the implementations of the invention and are not intended to limit the invention to such implementations. Unless the context clearly indicates otherwise, the singular form “one” and “one” is intended to include the plural form. It also should be understood that the invention uses the term(s) “including” and/or “includes” to include described feature, integer, step, operation, unit and/or component but does not exclude the existence of more features, integers, steps, operations, units, components and/or their combinations.

The invention will become apparent from the following detailed description taken with the accompanying drawings.

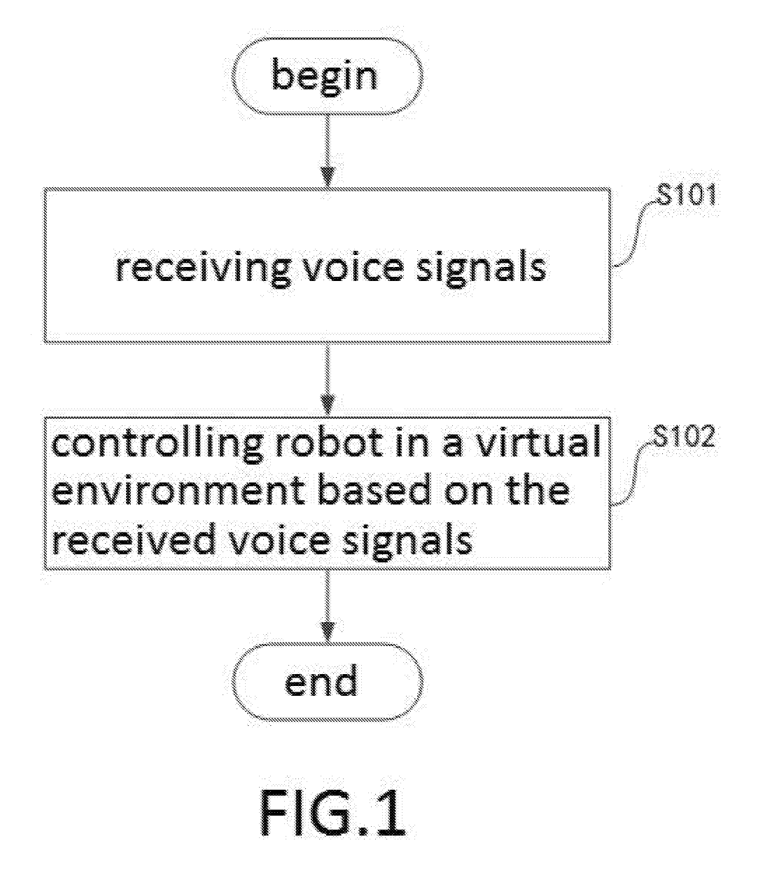

Reference is made to FIG. 1 which illustrates a flow chart of a robot training method under a virtual environment of the invention.

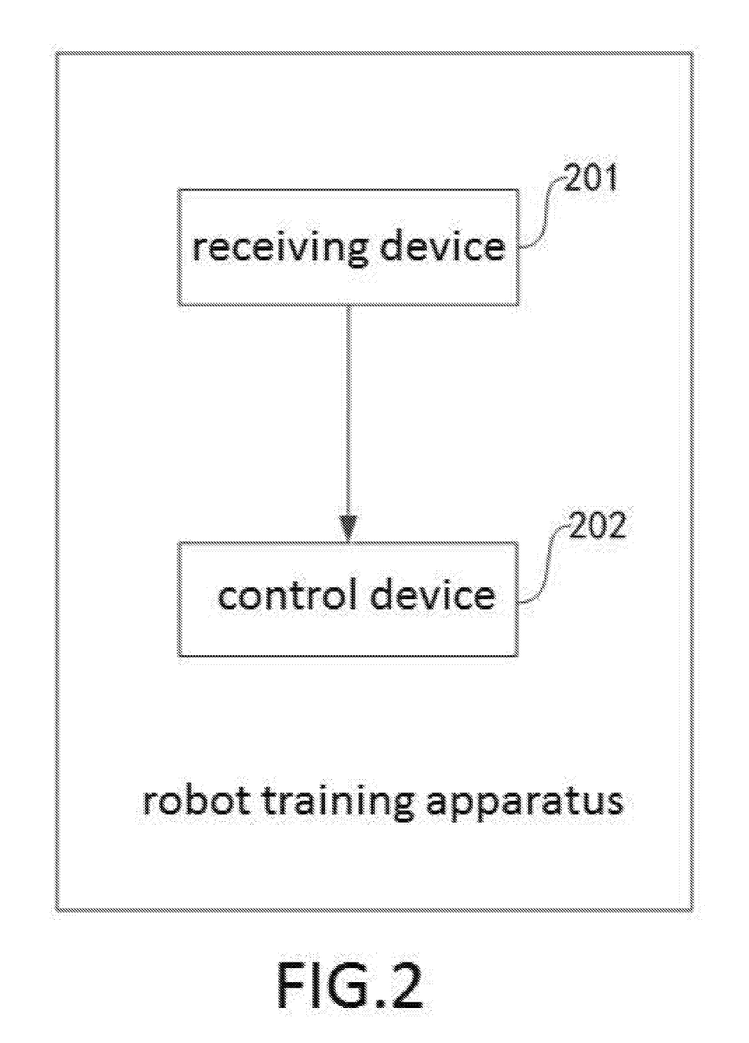

FIG. 1 is a flow chart illustrating a robot training method under a virtual environment according to the invention; and FIG. 2 is a block diagram of a robot training apparatus under the virtual environment according to the invention.

The robot training method is tied to the robot training apparatus (“training apparatus”) under the virtual environment of FIG. 2 and comprises the steps S101 and S102 as illustrated below.

Step S101: receiving voice signals.

Step S102: controlling a robot in the virtual environment in response to the received voice signals.

In the conventional technologies, robot training program, training time, etc. of robot training under a virtual environment are preset by a user including a patient. When the user wants to change the training program and/or the training time, the user is required to reset same. This means that not only the user has to do the reset by disrupting the training but also it brings inconvenience to the user in training. In addition, it is very inconvenient for injured users to set a training program and training time many times.

In comparison with the conventional technologies, the robot training method under virtual environment of the invention comprises the steps of receiving voice signals and controlling a robot in the virtual environment in response to the voice signals. Thus, the invention implements a robot training method by voice control. The user can select a desired training program and training time by means of voice signals. And in turn, the user can select a desired training program. Further, the user can shift the training time as desired.

This embodiment is a good solution to the problem of manual operation by the user by using a voice input operation. Any voice input operation can be done by using voice in a simple operation.

The robot training method of the invention can be applied to not only the medical fields but also the entertainment field. It is noted that the invention is not limited to such.

In step S101, the training apparatus receives the voice signals. During training, the user can transmit voice directly to the training apparatus so that the training apparatus can carry out the next step.

Preferably, the voice signals include a training program signal.

Specifically, prior to training, a user selects a desired training program by pronouncing a voice. And in turn, the training apparatus makes a selection based on the user's voice. Thus, user's manual setting of a training program is not required. It is a great convenience for the user to set a training program. Further, it is simple and can save user's time. In the training process, a user can pronounce a voice (i.e., a voice signal) to select another training program. After receiving the user's voice signal for selecting another training program, the training apparatus makes a determination in time, and switches the training program. This embodiment allows a user to switch training programs at any time. Further, it gives the user a better experience and saves the user's time.

Preferably, the voice signals include a training time signal.

Specifically, prior to training a user presets training time of a training program. Alternatively, a user can change the training time at any time of the training process. A user can select an optimum training time based on his or her schedule rather than the fixed time set by the conventional technologies.

In the embodiment, training time change is taken as an example below: in a training program a user selects a 20-minute training time through a voice signal. But approaching the end of the 20 minutes, the user wants to continue the training. Then the user can input a voice signal to the training apparatus to extend the training time to another 10 minutes, 20 minutes, etc. When the user feels tired during the extended period of time and wants to rest, the user can input the voice signal to the training apparatus to terminate the training.

In view of the above, the embodiment gives a great convenience to a user to select a training program and training time.

In the embodiment, the training includes medical rehabilitation training and game training. Of course, for those skilled in the art, the training is not limited to such.

In step S102, the training apparatus controls the robot in the virtual environment in response to the voice signals. In this way, the user can control the training apparatus directly by a voice signal, thereby achieving the purposes of user's free selection of training time and training program.

In addition, in the embodiment, the user can control training program to speed up or slow down the training by means of a voice signal, thereby maximizing the effect of user training.

Referring to FIG. 2, it is a block diagram of a robot training apparatus under the virtual environment according to the invention. In the embodiment, the robot training apparatus under the virtual environment (referred to as “training apparatus”) includes a device for receiving voice signals (hereinafter referred to as the “receiving device” 201) and a device for controlling a robot under the virtual environment based on the received voice signals (hereinafter referred to as “control device” 202).

In the conventional technologies, robot training program, training time, etc. of robot training under a virtual environment are preset by a user including a patient. When the user wants to change the training program and/or the training time, the user is required to reset same. This means that not only the user has to do the reset by disrupting the training but also it brings inconvenience to the user in training. In addition, it is very inconvenient for injured users to set a training program and training time many times.

In comparison with the conventional technologies, the robot training method under virtual environment of the invention comprises the steps of receiving voice signals and controlling a robot in the virtual environment in response to the voice signals. Thus, the invention implements a robot training method by voice control. The user can select a desired training program and training time by means of a voice signal. And in turn, the user can select a desired training program. Further, the user can shift the training time as desired.

This embodiment is a good solution to the problem of manual operation by the user by using a voice input operation. Any voice input operation can be done by using voice in a simple operation.

The robot training apparatus of the invention can be applied to not only the medical fields but also the entertainment field. It is noted that the invention is not limited to such.

In the training process, a user can pronounce a voice to the receiving device 201 so that the control device 202 can carry out the next step.

Preferably, the voice signals include a training program signal.

Specifically, prior to training, a user selects a desired training program by pronouncing a voice. And in turn, the training apparatus makes a selection based on the user's voice. Thus, user's manual setting of a training program is not required. It is a great convenience for the user to set a training program. Further, it is simple and can save user's time. In the training process, a user can pronounce a voice (i.e., a voice signal) to select another training program. After receiving the user's voice signal for selecting another training program, the training apparatus makes a determination in time, and switches the training program. This embodiment allows a user to switch training programs at any time. Further, it gives the user a better experience and saves the user's time.

Preferably, the voice signals include a training time signal.

Specifically, prior to training a user presets training time of a training program. Alternatively, a user can change the training time at any time of the training process. A user can select the right training time based on his or her schedule rather than the fixed time set by the conventional technologies.

In the embodiment, training time change is taken as an example below: in a training program a user selects a 20-minute training time through a voice signal. But approaching the end of the 20 minutes, the user wants to continue the training. Then the user can input a voice signal to the training apparatus to extend the training time to another 10 minutes, 20 minutes, etc. When the user feels tired during the extended period of time and wants to rest, the user can input the voice signal to the training apparatus to terminate the training.

In view of the above, the embodiment gives a great convenience to a user to select a training program and training time.

In the embodiment, the training includes medical rehabilitation training and game training. Of course, for those skilled in the art, the training is not limited to such.

The control device 202 controls the robot in the virtual environment in response to the voice signal. In this way, the user can control the training apparatus directly by a voice signal, thereby achieving the purposes of user's free selection of training time and training program.

In addition, in the embodiment, the user can control training program to speed up or slow down the training by means of a voice signal, thereby maximizing the effect of user training.

While the invention has been described in terms of preferred embodiments, those skilled in the art will recognize that the invention can be practiced with modifications within the spirit and scope of the appended claims.

What is claimed is:

1. A robot training method under a virtual environment comprising the steps of:
receiving voice signals; and
controlling a robot in the virtual environment in response to the received voice signals;
wherein the voice signals include a training time signal and a training program signal;
wherein prior to training a user is allowed to select training time of a predetermined training program by pronouncing a voice;
wherein the user is allowed to change the training time of the predetermined training program; and
wherein the user is allowed to select an optimum training time based on schedule.

2. The robot training method under a virtual environment of claim 1, wherein in the predetermined training program the user is allowed to select a 20-minute training time by inputting a voice signal; and wherein when approaching the end of the 20-minute training time, the user is allowed to continue the training by inputting a voice signal to a robot training apparatus to extend the 20-minute training time to another 10 minutes or 20 minutes.

3. The robot training method under a virtual environment of claim 1, wherein when the user feels tired during the extended period of time and wants to rest, the user is allowed to input a voice signal to the robot training apparatus to terminate the training.

4. A robot training apparatus under a virtual environment, comprising:
a receiving device for receiving voice signals; and
a control device for controlling a robot under the virtual environment based on the received voice signals;
wherein the voice signals include a training time signal and a training program signal;
wherein prior to training a user is allowed to select training time of a predetermined training program by pronouncing a voice;
wherein the user is allowed to change the training time of the predetermined training program; and
wherein the user is allowed to select an optimum training time based on schedule.

5. The robot training apparatus under a virtual environment of claim 4, wherein in the predetermined training program the user is allowed to select a 20-minute training time by inputting a voice signal; and wherein when approaching the end of the 20-minute training time, the user is allowed to continue the training by inputting a voice signal to the receiving device to extend the 20-minute training time to another 10 minutes or 20 minutes.

6. The robot training apparatus under a virtual environment of claim 4, wherein when the user feels tired during the extended period of time and wants to rest, the user is allowed to input a voice signal to the receiving device to terminate the training.
